(19) United States
(12) Patent Application Publication
(10) Pub. No.: US 2005/0186465 A1
(43) Pub. Date: Aug. 25, 2005

(54) Fuel cell system and stack used therein

(76) Inventors: Dong-Hun Lee, Suwon-si (KR); Ho-Jin Kweon, Suwon-si (KR); Seong-Jin An, Suwon-si (KR); Yeong-Chan Eun, Suwon-si (KR); Sung-Yong Cho, Suwon-si (KR); Jun-Won Suh, Suwon-si (KR); Jong-Man Kim, Suwon-si (KR); Hae-Kwon Yoon, Suwon-si (KR)

Correspondence Address: Robert E. Bushnell, Suite 300, 1522 K. Street, N.W., Washington, DC, 20005, US

(21) Appl. No.: 11/063,986

(22) Filed: Feb. 24, 2005

(30) Foreign Application Priority Data
Feb. 25, 2004 (KR) 10-2004-0012648

(51) Int. Cl. H01M 8/02; H01M 8/10

(52) U.S. Cl. 429/38; 429/32

(57) ABSTRACT

A fuel cell system includes a fuel supply unit for supplying fuel, an air supply unit for supplying air, and a stack for generating electric energy through an electro-chemical reaction between hydrogen supplied from the fuel supply unit and oxygen supplied from the air supply unit. The stack includes a membrane-electrode assembly and separators disposed on both sides of the membrane-electrode assembly. Each of the separators has a pathway for transferring the air or the hydrogen, and a ratio of the width to the depth of the pathway is within a range from 0.7 to 1.3.

### CLAIM OF PRIORITY

This application makes reference to, incorporates the same herein, and claims all benefits accruing under 35 U.S.C. §119 from an application for FUEL CELL SYSTEM AND STACK USED THEREIN earlier filed in the Korean Intellectual Property Office on 25 Feb. 2004 and there duly assigned Serial No. 10-2004-0012648.

### BACKGROUND OF THE INVENTION

1. Technical Field

The present invention relates to a fuel cell system, and more particularly, to a stack of a fuel cell system.

2. Description of the Related Art

A fuel cell is a system for producing electric power. In a fuel cell, chemical energy is directly converted into electric energy by using an electro-chemical reaction between oxygen and hydrogen contained in hydrocarbon-group materials such as methanol, ethanol, and natural gas, and air containing oxygen. Particularly, the fuel cell system is advantageous in that both the electric power generated through the electro-chemical reaction between oxygen and hydrogen without any combustion process and the heat generated as a by-product thereof can be utilized at the same time.

Depending on the types of electrolyte, the fuel cell can be classified into a phosphate fuel cell having an operating temperature range of 150 through 200° C. (Celsius), a molten carbonate fuel cell having a higher operating temperature range of 600 through 700° C., a solid oxide fuel cell having a higher operating temperature range over 1000° C., a polymer electrolyte membrane fuel cell (PEMFC) and an alkali fuel cell having a lower operating temperature range below 100° C. or a room temperature, and the like. These different types of fuel cells basically work using the same principles, but are different from one another in the kinds of fuel, operating temperature, catalyst, and electrolyte.

A polymer electrolyte membrane fuel cell (PEMFC) developed recently has an excellent output characteristic, a low operating temperature, and fast starting and response characteristics in comparison with other fuel cells. The PEMFC can be widely applied to mobile power sources used for vehicles, distributed power sources used for homes and buildings, small power sources used for electronic appliances, and the like.

The PEMFC basically includes a stack, a reformer, a fuel tank, and a fuel pump to constitute a system. The stack forms a main body of the fuel cell. The fuel pump supplies fuel of the fuel tank to the reformer. The reformer reforms the fuel to generate hydrogen gas and then supplies the hydrogen gas to the stack. Accordingly, the PEMFC supplies the fuel of the fuel tank to the reformer through operation of the fuel pump and reforms the fuel with the reformer to generate hydrogen gas. Then, the stack generates electric energy through an electro-chemical reaction between the hydrogen gas and oxygen.

On the other hand, a direct methanol fuel cell (DMFC) may be adopted. The DMFC can generate electric power by directly supplying liquid fuel containing hydrogen to the stack, and may not have the reformer in comparison with the PEMFC.

FIG. 7 is a partial cross-sectional view illustrating a state that a membrane-electrode assembly (MEA) is assembled with separators in a stack of a conventional fuel cell system.

Referring to FIG. 7, in the above fuel cell system, the stack which substantially generates electric energy is structured including a few through a few tens of unit cells realized with a membrane-electrode assembly (MEA), with separators (consisting of bipolar plates) provided on both sides thereof. In the MEA, an anode electrode and a cathode electrode are provided opposing one another with an electrolyte layer interposed therebetween. Also, the separator functions as a pathway for providing hydrogen gas and oxygen gas, which are required for a fuel cell reaction, as well as a conductor for connecting the anode electrode and the cathode electrode of each MEA in series.

Accordingly, through the separators, hydrogen gas is supplied to the anode electrode and oxygen or air is supplied to the cathode electrode. During this process, an oxidation reaction of the hydrogen gas occurs in the anode electrode, and a de-oxidation reaction of the oxygen occurs in the cathode electrode, so that electric energy, heat, and water are generated by electron movement occurring at the same time.

The separators 53 are provided on both sides of the membrane-electrode assembly 51 to form a hydrogen pathway 55 for supplying hydrogen gas and an air pathway 57 for supplying air containing oxygen. By means of the hydrogen pathway 55 and the air pathway 57, the separators 53 have a rib structure in which closely adhering portions 59 and gap portions are alternately arranged with respect to the membrane-electrode assembly 51. The closely adhering portions 59 are substantially formed by a rib structure in which channels forming the gap portions 61 are interposed therebetween.

Typically, when the separators 53 are arrange with the MEA 51 interposed therebetween, since the hydrogen pathway 55 and the air pathway 57 are perpendicularly crossed with one another, the number of the hydrogen pathways 55 is illustrated as one, and the number of the air pathways 57 is illustrated as several in FIG. 7.

In the meantime, the stack in the fuel cell may enhance fuel diffusion capability in order to improve efficiency of the fuel cell system. In this case, it is required to design the structure so as to maintain sufficient pressure necessary for the fuel diffusion. One of these design requirements is a channel configuration of the hydrogen pathway 55 and the air pathway 57.

In other words, the channel configuration of the separators 53 is a key factor influencing how efficiently the fuel, i.e., hydrogen and air, can be diffused to a gas diffusion layer in the membrane-electrode assembly 51 and determining a contact resistance for the electric current generated in the membrane-electrode assembly 51.

In order to improve efficiency of the fuel cell system, it is important to optimize the channel configuration formed on both sides of the membrane-electrode assembly 51. Substantially, the channel configuration is determined by a ratio Wc/Dc of the channel width Wc to the channel depth Dc. However, there have been no requirement on such a ratio of the separator 53 in prior arts. Therefore, this has caused limitation on improving efficiency of the fuel cell.

### SUMMARY OF THE INVENTION

The present invention is made to solve the above and other problems, and an object of the present invention is to provide a fuel cell system and a stack used therein capable of optimizing the ratio of the width to the depth of the channel formed between the separator and the membrane-electrode assembly to improve fuel diffusion efficiency and thus preventing internal pressure decrease.

It is another object to have the fuel cell system and the stack to select a certain dimension of the pathway formed on the separators which are closely adhered to the membrane-electrode assembly, thereby improving the diffusion capability of fuel such as hydrogen and air and prevent pressure decrease generated in the stack while a contact resistance of the electric current generated in the stack is maintained within a predetermined range.

It is yet another object to provide a fuel cell system and a stack used therein that is easy to implement, manufacture and cost effective.

According to an aspect of the present invention, there is provided a fuel cell system including: a fuel supply unit for supplying fuel; an air supply unit for supplying air; and a stack for generating electric energy through an electro-chemical reaction between hydrogen supplied from the fuel supply unit and oxygen supplied from the air supply unit, wherein the stack includes a membrane-electrode assembly and separators disposed on both sides of the membrane-electrode assembly, and wherein each of the separators has a pathway for transferring the air or the hydrogen, and a ratio of the width to the depth of the pathway is within a range from 0.7 to 1.3.

The separators may be closely adhered to both sides of the membrane-electrode assembly, and the pathway may include a hydrogen pathway provided on the side of an anode electrode of the membrane-electrode assembly and an air pathway provided on the side of a cathode electrode of the membrane-electrode assembly.

The hydrogen pathway may be perpendicularly crossed with the air pathway.

The pathway may include a first region for transferring water and a second region for transferring hydrogen gas or air.

The second region excluding the first region may be formed to be substantially square.

According to another aspect of the present invention, there is provided a stack of a fuel cell system for generating electric energy through an electro-chemical reaction between hydrogen supplied from a fuel supply unit and oxygen supplied from an air supply unit, the stack including: a membrane-electrode assembly; and separators disposed on both sides of the membrane-electrode assembly, wherein each of the separators has a pathway for transferring the hydrogen or air, and a ratio of the width to the depth of the pathway is within a range from 0.7 to 1.3.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram illustrating a fuel cell system according to the present invention;

FIG. 2 is an exploded perspective view illustrating a stack of a fuel cell system according to the present invention;

FIG. 3 is an exploded perspective view illustrating a state when one of the separators used in a stack of a fuel cell system according to the present invention is rotated;

FIG. 4 is a partial cross-sectional view illustrating a state when a membrane-electrode assembly and separators according to the present invention are assembled together;

FIG. 5 is an enlarged cross-sectional view illustrating a separator according to the present invention;

FIG. 6 is a graph illustrating relations between a channel ratio of a separator according to the present invention and a relative power density; and

FIG. 7 is a partial cross-sectional view illustrating a state when a membrane-electrode assembly and separators are assembled together in a conventional stack of a fuel cell system.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

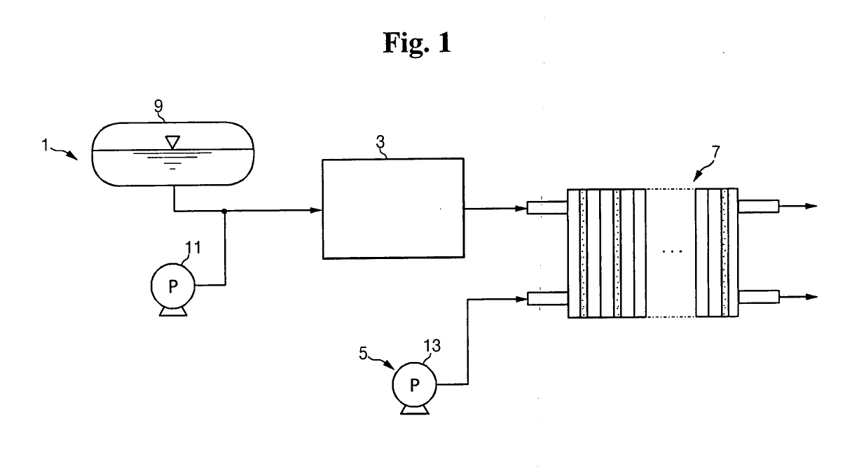

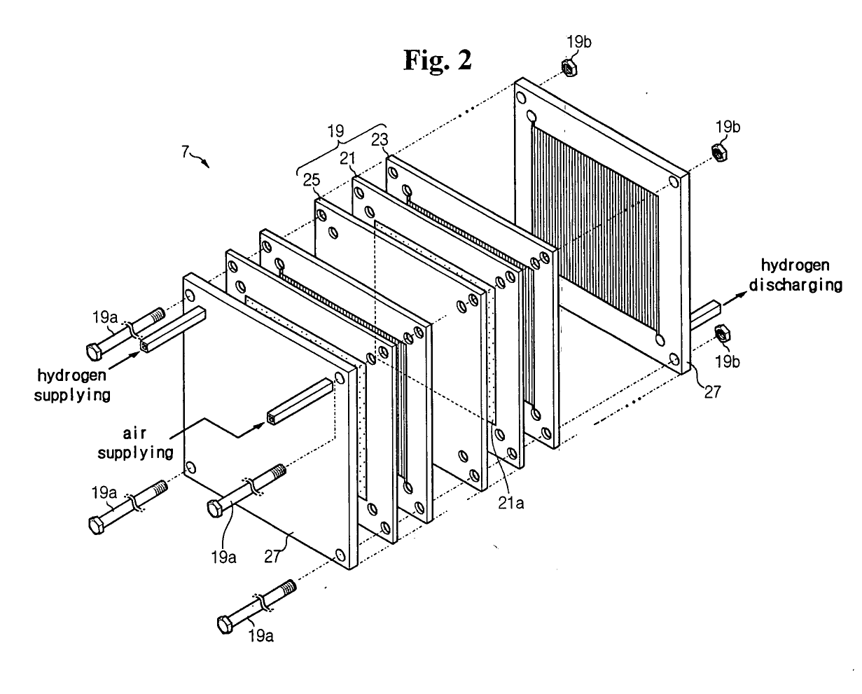

FIG. 1 is a schematic diagram illustrating a fuel cell system according to the present invention. Also, FIG. 2 is an exploded perspective view illustrating a stack of a fuel cell system according to the present invention.

Referring to FIGS. 1 and 2, a fuel cell system according to the present invention includes a fuel supply unit 1 for supplying fuel (i.e., hydrogen), a reformer 3, an air supply unit 5 for supplying air containing oxygen, and a stack 7 for generating electric energy through an electro-chemical reaction between the oxygen and the hydrogen supplied from the fuel supply unit 1 and the air supply unit 5, respectively.

The fuel supply unit 1 includes a fuel tank 9 and a fuel pump 11, so that liquid fuel, such as methanol, ethanol, and natural gas, in the fuel tank 9 is supplied to the reformer 3 by operating the fuel pump 11, and hydrogen gas reformed through the reformer 3 is supplied to the inside of the stack 7.

The fuel cell system according to the present invention may be a DFMC type in which the liquid fuel is directly supplied to the stack 7 to generate electricity. The DFMC system does not require the reformer 3 in comparison with the PEMFC system shown in FIG. 1. Now, descriptions will be given by exemplifying a PEMFC type system for a convenience.

The air supply unit 5 includes an air pump 13 to supply air containing oxygen to the stack 7.

The stack 7 receives hydrogen gas from the fuel supply unit 1 and the reformer 3, and receives oxygen from the air supply unit 5. Then, the received hydrogen and oxygen are electro-chemically reacted to generate electric energy, thereby producing heat and water as by-products.

The stack 7 according to the present invention includes a plurality of electricity generating units 19 for inducing an oxidation/de-oxidation reaction between the external air and the hydrogen gas reformed through the reformer 3 to generate electric energy.

Each electricity generating unit 19 functions as a basic unit for generating electricity, and includes a membrane-electrode assembly (MEA) 21 for inducing an oxidation/de-oxidation reaction between the hydrogen gas and the oxygen gas and separators 23 and 25 (known as a bipolar plate in the art) disposed on both sides of the membrane-electrode assembly 21 for supplying hydrogen and air containing oxygen to the membrane-electrode assembly 21.

In the electricity generating unit 19, the membrane-electrode assembly 21 is arranged at the center and the separators 23 and 25 are disposed on both sides of the membrane-electrode assembly 21 to constitute one unit. Therefore, a plurality of such units constitute a stack 7 according to the present invention. The electricity generating units 19 located at outermost sides of the stack 7 include an end plate 27 having a construction slightly different from the separators 23 and 25. The electricity generating units 19 are assembled together with bolts 19a and nuts 19b combined with each other to constitute a stack 7.

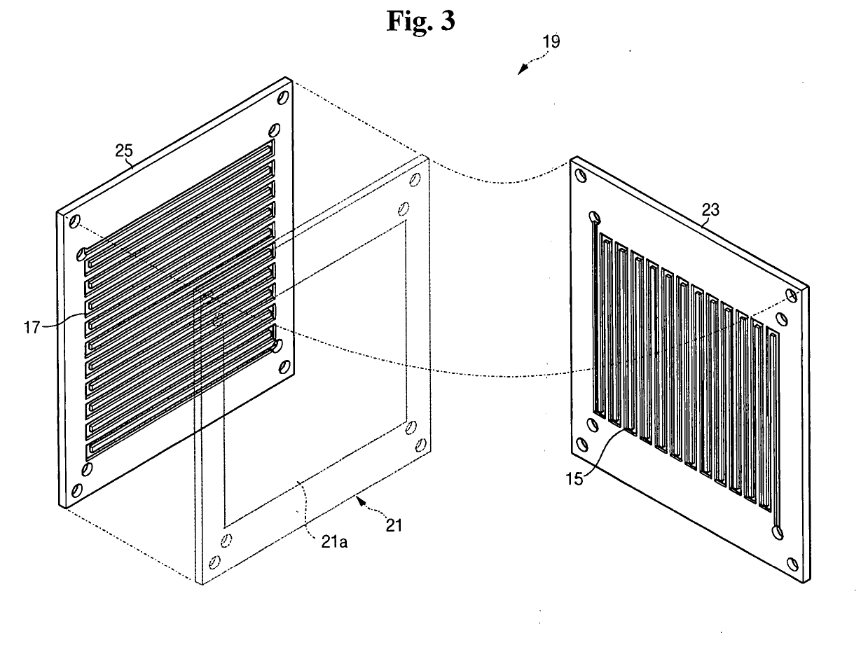

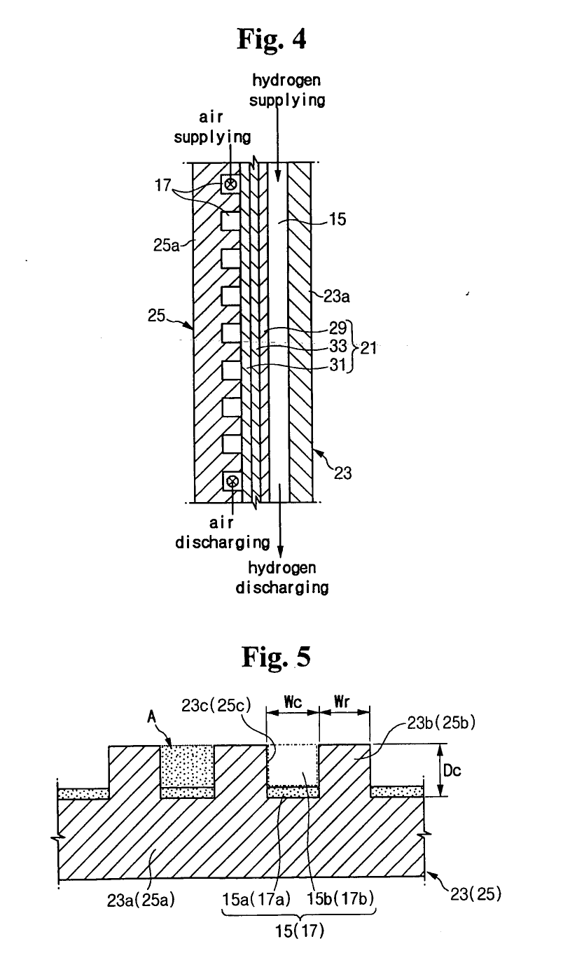

FIG. 3 is an exploded perspective view illustrating a state when one of the separators used in a stack of a fuel cell system according to the present invention is rotated. Also, FIG. 4 is a partial cross-sectional view illustrating a state when a membrane-electrode assembly and separators according to the present invention are assembled together.

Referring to FIGS. 3 and 4, the separators 23 and 25 are closely adhered to the membrane-electrode assembly 21 interposed therebetween, so as to form a hydrogen pathway 15 and an oxygen pathway 17 on both sides. The hydrogen pathway 15 is associated with the anode electrode 29 of the membrane-electrode assembly 21, and the oxygen pathway 17 is associated with the cathode electrode 31 of the membrane-electrode assembly 21.

Also, the hydrogen pathway 15 and the oxygen pathway 17 are formed on the bodies 23a and 25a of the separators 23 and 25, respectively, in a straight-lined rib structure having a predetermined interval, and they are alternately crossed with each other on both sides when assembled. Of course, the present invention is not limited by such a structure, and other arrangements can be made for the hydrogen and oxygen pathways 15 and 17.

When the separators 23 and 25 are assembled with and pressed onto the membrane-electrode assembly 21 interposed therebetween, as shown in FIG. 3, the hydrogen pathway 15 formed on one separator 23 is aligned in a vertical direction, and the oxygen pathway 17 formed on the other separator 25 is aligned in a horizontal direction, so that they are perpendicularly crossed.

The membrane-electrode assembly 21 has an active region 21a having a predetermined surface area capable of inducing an oxidation/de-oxidation reaction. On both sides of the active region 21a, the anode electrode 29 and the cathode electrode 31 are provided. Further, a membrane 33 is provided between the electrodes 29 and 31.

The anode electrode 29 formed on one side of the membrane-electrode assembly 21 is a part for receiving hydrogen gas via the hydrogen pathway 15 arranged between the separator 23 and the membrane-electrode assembly 21. Also, the anode electrode 29 has a gas diffusion layer (GDL) for supplying hydrogen gas to a catalyst layer. In the catalyst layer, the hydrogen gas is oxidized, and the resulting electrons are transferred to the external. Accordingly, such electron movement causes electric currents, and hydrogen ions are transferred to the cathode electrode 31 through the membrane 33.

The cathode electrode 31 formed on the other side of the membrane-electrode assembly 21 is a part for receiving air containing oxygen via the oxygen pathway 17 arranged between the separator 25 and the membrane-electrode assembly 21. Similarly, the cathode electrode 31 has a gas diffusion layer for supplying the air to the catalyst layer. In the catalyst layer, the oxygen is de-oxidized to convert the oxygen ions into hydrogen ions and water.

The membrane 33 is a solid polymer electrolyte having a thickness of 50 through 200 μm (micrometers or microns). The membrane 33 performs an ion exchange function, by which the hydrogen ions generated in the catalyst layer of the anode electrode 29 are transferred to the catalyst layer of the cathode electrode 31, and then combined with the oxygen ions in the cathode electrode 31 to produce water.

FIG. 5 is an enlarged cross-sectional view illustrating a separator according to the present invention. Since both separators 23 and 25 have a substantially identical structure, only one separator 23 is representatively illustrated in FIG. 5 for a convenience. However, the following descriptions will be made to both separators 23 and 25.

Referring to FIG. 5, the separators 23 and 25 are provided with the hydrogen pathway 15 and the oxygen pathway 17, respectively, for supplying the hydrogen gas and the air containing oxygen necessary for the oxidation/de-oxidation reaction in the anode electrode 29 and the cathode electrode 31 of the membrane-electrode assembly 21, as described above.

More specifically, the hydrogen pathway 15 and the oxygen pathway 17 are formed by closely arranging the separators 23 and 25 onto the membrane-electrode assembly 21 interposed therebetween. In this case, the hydrogen pathway 15 is formed on the side of the anode electrode 29, and the oxygen pathway 17 is formed on the side of the cathode electrode 31 in the membrane-electrode assembly 21.

The hydrogen pathway 15 and the oxygen pathway 17 are formed by channels 23c and 25c, corresponding to spaces between the ribs 23b and 25b, which are formed on the one side of the bodies 23a and 25a of the separators 23 and 25, respectively, with a predetermined interval. In this structure, when the surface area of the active region 21a of the membrane-electrode assembly 21 is established, the size and the shape of the channels 23c and 25c are established, and then the size and the shape of the ribs 23b and 25b can be accordingly established. In this embodiment, the cross-sections of the channels 23c and 25c and the ribs 23b and 25b are shown as a substantially rectangular shape when viewed from a longitudinal direction with respect to the vertical direction. However, the present invention is not limited by this, but various shapes such as a half circle and a trapezoid can be adopted.

The channel 23c forming the hydrogen pathway 15 is connected to the reformer 3, and the channel 25c forming the oxygen pathway 17 is connected to the pump 13.

Accordingly, one end plate 27 is supplied with the hydrogen gas generated in the reformer 3 and the oxygen transported by the pump 13 via the hydrogen pathway 15 and the oxygen pathway 17, respectively. Similarly, the other end plate 27 is supplied with the air and the hydrogen gas remained after the electro-chemical reaction in the membrane-electrode assembly 21.

In the pathways 15 and 17, the widths Wr of the ribs 23b and 25b relate to portions through which the hydrogen gas and the air do not flow, and the widths Wc of the channels 23c and 25c and the depth Dc of the channels 23c and 25c relate to portions through which the hydrogen gas and the air flow. Therefore, the surface areas A of the pathways 15 and 17 formed by the channels 23c and 25c are determined by the widths Wc and the depths Dc of the channels 23c and 25c.

When the widths of the channels 23c and 25c (or the widths Wr and the depths Dc of the ribs 23b and 25b) are not consistent in the entire surface area, the widths Wc of the channels 23c and 25c (or the width Wr and the depth Dc of the ribs 23b and 25b) may be preferably determined by their mean value. In addition, when the bottoms of the channels 23c and 25c are not flat, the depths Dc of the channels 23c and 25c may be preferably determined by their mean value or a measurement from the middle of the channel 23c, 25c.

These pathways 15 and 17 may be separately called a first region 15a, 17a and a second region 15b, 17b. The first region 15a, 17a constitutes a pathway for transferring the water generated in the stack from the hydrogen gas and the oxygen. The second region 15b, 17b constitutes a pathway for transferring the hydrogen gas and the oxygen to the active region 21a of the membrane-electrode assembly 21. Therefore, the hydrogen pathway 15 and the oxygen pathway 17 uses the surface area of the second region 15b, 17b excluding the surface area of the first region 15a, 17a to supply the hydrogen and the oxygen.

In order to improve efficiency of the fuel cell, in the separators 23 and 25 having the aforementioned structure, it is required to improve diffusion capabilities of hydrogen and oxygen in the gas diffusion layer of the membrane-electrode assembly 21 and prevent pressure decrease in the stack 7 while maintaining a contact resistance of the electric current generated from the inside of the stack 7 within an allowable range.

For this purpose, in the aforementioned separators 23 and 25, it is necessary to control the shapes of the channels 23c and 25c, that is, the pathways 15 and 17 partitioned by the first regions 15a, 17a and the second regions 15b, 17b. Accordingly, the present embodiment discloses optimization of the ratio of the width Wc to the depth Dc of the channel 23c, 25c for transferring the hydrogen gas and the oxygen in the separator 23 and 25.

As a performance measurement of the fuel cell for improving both the diffusion capabilities of hydrogen gas and air and the energy required to supply hydrogen gas and air, a relative power density (RPD) is used. The RPD can be calculated by obtaining the difference between the power generated in the stack 7 and the power consumed to supply the hydrogen gas and the air which are used as fuel in the stack 7, and then dividing the difference by the total area of the active region 21a in the stack 7. The result of the calculation is shown in Table 1 as follows.

Thus, Table 1 shows relations between the RPD and the ratio of the width Wc to the depth Dc of the channel 23c, 25c.

TABLE 1

| | | | | | |
|---|---|---|---|---|---|
| Ratio (Wc/Dc) | 0.5 | 0.7 | 1 | 1.3 | 1.5 |
| RPD (mW/cm²) | 202 | 258.70 | 254 | 253 | 220 |

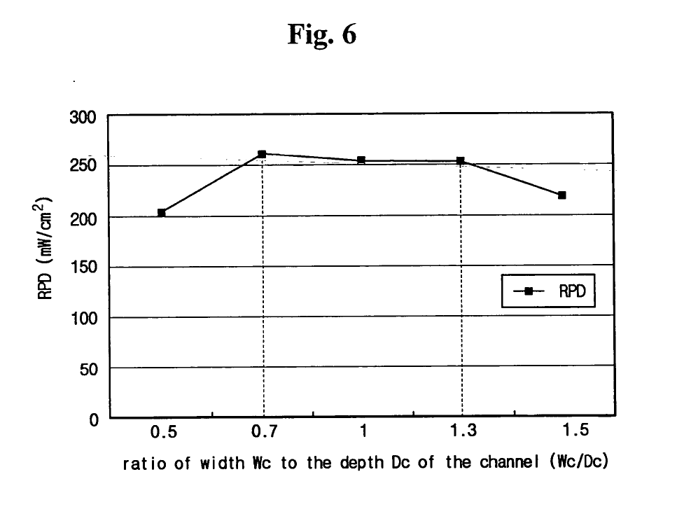

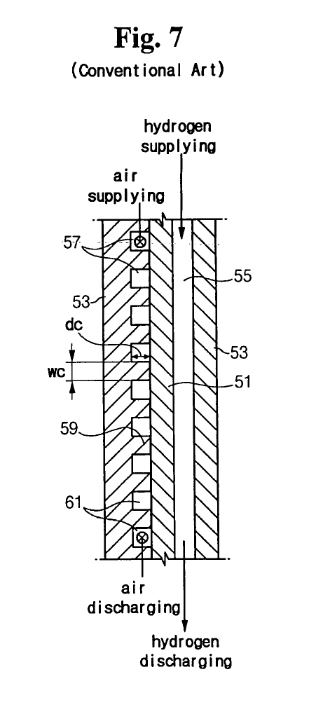

In order to measure performance of the fuel cell, the hydrogen gas was supplied to the anode electrode 29, and the air was supplied to the cathode electrode 31. Then, the RPD was measured by altering the ratio Wc/Dc of the width Wc to the depth Dc of the channel 23c, 25c in a non-heated state. The result of Table 1 can be illustrated in a graph as shown in FIG. 6.

FIG. 6 is a graph illustrating the result of measuring relations between the RPD and the ratio of the width to the depth of the channel 23c, 25c in the hydrogen pathway and the oxygen pathway.

Referring to FIG. 6, it is recognized that the RPD is high (this means efficiency of a fuel cell is excellent) when the ratio Wc/Dc is within a range from 0.7 to 1.3, but the RPD is low (this means efficiency of a fuel cell is poor) when the ratio Wc/Dc is lower than 0.7 or higher than 1.3.

When the ratio Wc/Dc is lower than 0.7, the width Wc is too small relative to the depth Dc of the channel 23c, 25c, so that the channel shape 15, 17 becomes a narrow and tall rectangle with respect to the same area (in FIG. 5). This would increase reduction of an internal pressure. Therefore, more power will be consumed to supply the hydrogen gas and the air than the power generated in the stack 7, thereby decreasing the RPD.

When the ratio Wc/Dc is higher than 1.3, the depth Dc is too small relative to the width Wc of the channel 23c, 25c, so that the channel shape 15, 17 becomes wide and short rectangle with respect to the same area (in FIG. 5). This would also increase reduction of an internal pressure. Therefore, similar to the above case, more power will be consumed to supply the hydrogen gas and the air than the power generated in the stack 7, thereby decreasing the RPD.

On the contrary, when the ratio Wc/Dc is within a range from 0.7 to 1.3, the width Wc is appropriate relative to the depth Dc of the channel 23c, 25c, so that the channel shape 15, 17 is also appropriate with respect to the same area. This would prevent reduction of an internal pressure. Therefore, smaller power will be consumed to supply the hydrogen gas and the air in comparison with the power generated in the stack 7, thereby increasing the RPD.

From the above measurement, it is recognized that, if the pathway 15, 17 is formed on the same area, the channel shape 23c, 25c influences friction between the fluid including the hydrogen gas and the air and the surface of the pathway 15, 17, and thus determines the amount of the pressure decrease.

Therefore, the friction relates to the shape of the cross-section of the channel 23c, 25c in the pathway 15, 17 through which the hydrogen gas and the air flow. Finally, it is possible to know that the pathway 15, 17 can be considered optimal when the amount of water generated in the stack 7 during the electric energy is generated is first calculated, the first region 15a, 17a is determined based on the amount of water, and then the second region 15b, 17b is formed to be substantially square.

In the fuel cell system and the stack used therein according to the present invention, it is possible to optimally select the ratio of the width to the depth of the pathway formed on the separators which are closely adhered to the membrane-electrode assembly. Therefore, it is possible to improve diffusion capability of fuel such as hydrogen and air and prevent pressure decrease generated in the stack while a contact resistance of the electric current generated in the stack is maintained within a predetermined range. Finally, efficiency of the fuel cell can be improved.

Although embodiments of the present invention have been described in detail hereinabove in connection with certain exemplary embodiments, it should be understood that the invention is not limited to the disclosed exemplary embodiments, but, on the contrary is intended to cover various modifications and/or equivalent arrangements included within the spirit and scope of the present invention, as defined in the appended claims.

1. A fuel cell system comprising:
a fuel supply unit for supplying fuel;
an air supply unit for supplying air; and
a stack for generating electric energy through an electro-chemical reaction between hydrogen supplied from said fuel supply unit and oxygen supplied from said air supply unit,
wherein said stack comprises a membrane-electrode assembly and separators disposed on both sides of said membrane-electrode assembly, and
wherein each of said separators includes a pathway for transferring the air or the hydrogen, and a ratio of the width to the depth of the pathway is within a range from 0.7 to 1.3.

2. The fuel cell system of claim 1, wherein the separators are closely adhered to both sides of said membrane-electrode assembly, and the pathway includes a hydrogen pathway provided on the side of an anode electrode of the membrane-electrode assembly and an air pathway provided on the side of a cathode electrode of said membrane-electrode assembly.

3. The fuel cell system of claim 2, wherein said hydrogen pathway is perpendicularly crossed with respect to the air pathway.

4. The fuel cell system of claim 1, wherein said pathway includes a first region for transferring water and a second region for transferring hydrogen gas or air.

5. The fuel cell system of claim 1, wherein the second region excluding the first region is formed to be substantially square.

6. The fuel cell system of claim 2, with said separators firmly and directly attached to both sides of said membrane-electrode assembly forming said hydrogen and oxygen pathways, and with said hydrogen pathway and said oxygen pathway being formed by channels, corresponding to spaces between ribs, which are formed on one side of bodies of said separators, respectively, with a predetermined interval.

7. A stack of a fuel cell system for generating electric energy through an electro-chemical reaction between hydrogen supplied from a fuel supply unit and oxygen supplied from an air supply unit, the stack comprising:
a membrane-electrode assembly; and
separators disposed on both sides of said membrane-electrode assembly,
wherein each of the separators has a pathway for transferring the hydrogen or air, and a ratio of the width to the depth of the pathway is within a range from 0.7 to 1.3.

8. The stack of claim 7, wherein the pathway comprises a first region for transferring water and a second region for transferring hydrogen gas and air.

9. The stack of claim 8, wherein the second region excluding the first region is formed to be substantially square.

10. The stack of claim 7, with said separators directly and closely adhered to said membrane-electrode assembly interposed therebetween to form said pathway, and with said pathway including being formed by channels, corresponding to spaces between the ribs, which are formed on one side of the bodies of said separators, respectively, with a predetermined interval.

11. The stack of claim 10, with the ribs being of a shape selected from a group consisting of a rectangle, a half circle and a trapezoid.

12. The stack of claim 10, with the channels including a first region for transferring water and a second region for transferring hydrogen gas and air.

13. The stack of claim 12, with the first region and second region being formed in substantially the same area.
